(19) United States
(12) Patent Application Publication
(10) Pub. No.: US 2024/0119298 A1
(43) Pub. Date: Apr. 11, 2024

(54) ADVERSARIAL ATTACKS FOR IMPROVING COOPERATIVE MULTI-AGENT REINFORCEMENT LEARNING SYSTEMS

(71) Applicant: INTERNATIONAL BUSINESS MACHINES CORPORATION, Armonk, NY (US)

(72) Inventors: Nhan Huu Pham, Tarrytown, NY (US); Lam Minh Nguyen, Ossining, NY (US); Jie Chen, Briarcliff Manor, NY (US); Thanh Lam Hoang, Maynooth (IE); Subhro Das, Cambridge, MA (US)

(21) Appl. No.: 17/951,870

(22) Filed: Sep. 23, 2022

(51) Int. Cl. G06N 3/092

(52) U.S. Cl. CPC G06N 3/092

(57) ABSTRACT

In aspects of the disclosure, a method comprises training, by a computing system, a dynamics model of a cooperative multi-agent reinforcement learning (c-MARL) environment. The method further comprises processing, by the computing system, a perturbation optimizer to generate a state perturbation of the c-MARL environment, based on the dynamics model. The method further comprises selecting one or more agents of the c-MARL system as having enhanced vulnerability. The method further comprises attacking, by the computing system, the c-MARL system based on the state perturbation and the selected one or more agents.

### BACKGROUND

Aspects of the present invention relate generally to machine learning (ML) and, more particularly, to cooperative multi-agent reinforcement learning (c-MARL).

Reinforcement learning (RL) systems and methods have been a primary field of productive advances in machine learning (ML) and artificial intelligence (AI), and have achieved state of the art performance superior to any competing systems based on any other machine learning techniques, in some applications. Multi-agent reinforcement learning introduces substantial further complexity beyond that of single-agent reinforcement learning.

The following disclosure(s) are submitted under 35 U.S.C. 102(b)(1)(A):

DISCLOSURES: “Evaluating Robustness of Cooperative MARL,” Pham et al. (i.e. the identical inventors of the present disclosure, plus one non-inventor co-author who obtained the invention from the inventors), submitted to openreview.net pre-print server, Sep. 28, 2021, 20 pages; “Evaluating Robustness of Cooperative MARL: A Model-Based Approach,” Pham et al. (i.e. the identical inventors of the present disclosure, plus one non-inventor co-author who obtained the invention from the inventors), submitted to arxiv.org pre-print server, Feb. 7, 2022, 15 pages; both listed in and provided with IDS.

### SUMMARY

In a first aspect of the invention, there is a computer-implemented method including: training, by a computing system, a dynamics model of a cooperative multi-agent reinforcement learning (c-MARL) environment. The method further comprises processing, by the computing system, a perturbation optimizer to generate a state perturbation of the c-MARL environment, based on the dynamics model. The method further comprises selecting one or more agents of the c-MARL system as having enhanced vulnerability. The method further comprises attacking, by the computing system, the c-MARL system based on the state perturbation and the selected one or more agents.

In another aspect of the invention, there is a computer program product including one or more computer readable storage media having program instructions collectively stored on the one or more computer readable storage media. The program instructions are executable to train a dynamics model of a cooperative multi-agent reinforcement learning (c-MARL) environment. The program instructions are further executable to process a perturbation optimizer to generate a state perturbation of the c-MARL environment, based on the dynamics model. The program instructions are further executable to select one or more agents of the c-MARL system as having enhanced vulnerability. The program instructions are further executable to attack the c-MARL system based on the state perturbation and the selected one or more agents.

In another aspect of the invention, there is system including a processor, one or more computer readable storage media, and program instructions collectively stored on the one or more computer readable storage media. The program instructions are executable to train a dynamics model of a cooperative multi-agent reinforcement learning (c-MARL) environment. The program instructions are further executable to process a perturbation optimizer to generate a state perturbation of the c-MARL environment, based on the dynamics model. The program instructions are further executable to select one or more agents of the c-MARL system as having enhanced vulnerability. The program instructions are further executable to attack the c-MARL system based on the state perturbation and the selected one or more agents.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIG. 3 shows a flowchart of an exemplary method in accordance with aspects of the invention.

FIG. 4 depicts a conceptual diagram of a cooperative multi-agent reinforcement learning (c-MARL) system, in accordance with aspects of this disclosure.

FIG. 5 depicts a conceptual diagram of a cooperative multi-agent reinforcement learning (c-MARL) system in a perturbed state due to an adversarial attack by a c-MARL model-based attack (c-MBA) system, such as the c-MBA system of FIGS. 1 and 2, in accordance with aspects of the present disclosure.

FIG. 6A depicts a conceptual diagram of a c-MARL model-based attack (c-MBA) system interacting with a c-MARL system to carry out c-MBA attacks on the c-MARL system, in accordance with aspects of the present disclosure.

FIG. 6B shows a system of equations that a c-MBA system may carry out to perform adversarial perturbation attack training runs, in accordance with aspects of this disclosure.

FIG. 7 depicts a grid of comparative representative time series of images showing the state of a standardized reinforcement learning (RL) control article under control by a MARL agent set in various comparative baselines (rows 1 through 4) and by a c-MBA system in accordance with aspects of the present disclosure (row 5).

FIG. 8 depicts a graph of mean RL rewards relative to noise levels for a c-MBA system in accordance with aspects of the present disclosure, compared to the same comparative baseline, previously known, model-free adversarial RL control software attacks discussed above with reference to FIG. 7, in accordance with aspects of this disclosure.

FIG. 9 depicts a graph of mean RL rewards relative to noise levels for various different example implementations of c-MBA systems, in accordance with aspects of the present disclosure.

### DETAILED DESCRIPTION

Aspects of the present invention relate generally to cooperative multi-agent reinforcement learning (c-MARL) and, more particularly, to systems and methods configured to engage in adversarial attacks on c-MARL systems and to evaluate and improve their robustness. According to aspects of the invention, an RL attack system configured for performing adversarial attacks on a c-MARL system may be trained based on a model of a targeted failure state of a c-MARL system. The targeted failure state may be defined as contrary to the reinforcement learning (RL) training reward function of the c-MARL environment, in various examples. In embodiments, the attack model is configured for degrading and defeating the performance of the previously trained c-MARL policy of the c-MARL system. In this manner, implementations of the invention may provide greater effectiveness, quality assurance, and vulnerability resistance to a broad variety of real-world reinforcement learning (RL) AI systems, such as robots, self-driving vehicles, electrical grid control, and many others.

Various examples of this disclosure are directed to a method for evaluating cooperative multi-agent reinforcement learning robustness. An example method includes training a machine learning model, e.g., via a supervised learning training process, to predict a next state for a multi-agent reinforcement learning system; computing a current system action according to a current system state; predicting a next system state having a minimum distance from a targeted failure state, according to the machine learning model; determining a system perturbation according to the next system state; and determining a state perturbation, based on a given perturbation budget, e.g., based on resources available to bring to bear for performing system state perturbation. Some examples further include predicting the next system state having a minimum distance from a targeted failure state, according to a budget constraint. In some examples, the machine learning model comprises a neural network. Various examples further include selecting a set of system agents according to a minimized reward for a set of system actions, and generating state perturbation to make the predicted next state closer or closest to the targeted failure state. Various examples may further select a subset of one or more of the target agents based on their vulnerability, and seek out agents that are more particularly vulnerable. Various further aspects are described as follows and depicted in the accompanying figures.

Implementations of this disclosure are necessarily rooted in computer technology. For example, the steps of performing, by a computing system, training of a cooperative multi-agent reinforcement learning (c-MARL) system; performing, by the computing system, supervised learning training of an attack system configured for attacking the c-MARL system, wherein the training of the attack system comprises training with an attack model; and attacking, by the computing system, the c-MARL system with the attack system, are necessarily computer-based and cannot be performed in the human mind. Training and using a multi-agent reinforcement learning (MARL) model are, by definition, performed by a computer and cannot conceivably be performed in the human mind (or with pen and paper) due to the complexity and massive amounts of calculations involved. For example, a neural network may have millions or even billions of weights that represent connections among nodes in one or more layers of the model. Values of these weights are adjusted, e.g., via backpropagation and stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model, and is even impossible for a human mind to conceive of or reproduce in a way that is categorically further from human mental conception than any traditional, human-written algorithmic software, as has been emphasized by noted experts in the field of art.

It is understood in the art that developing “adversarial” and “attack” techniques, methods, and systems can be a productive direction for advancing the state of the art for positive, productive purposes, including for developing further techniques, methods, and systems for mitigating or overcoming “adversarial” and “attack” measures, and that countering “adversarial attack” measures can be a productive component of developing general systems and methods with higher performance across a broad range of beneficial performance characteristics than may be possible without using and understanding “adversarial” and “attack” measures and/or how to counter them. Thus, it is understood in the art that developing “adversarial” and “attack” techniques, methods, and systems are part of benign and beneficial progress in advancing the art and its applications. For example, better understanding and developing more effective adversarial attacks on c-MARL systems and methods is an important realm in which to evaluate and improve upon c-MARL systems and methods and their robustness, with broad, general applicability across a wide variety of useful applications.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

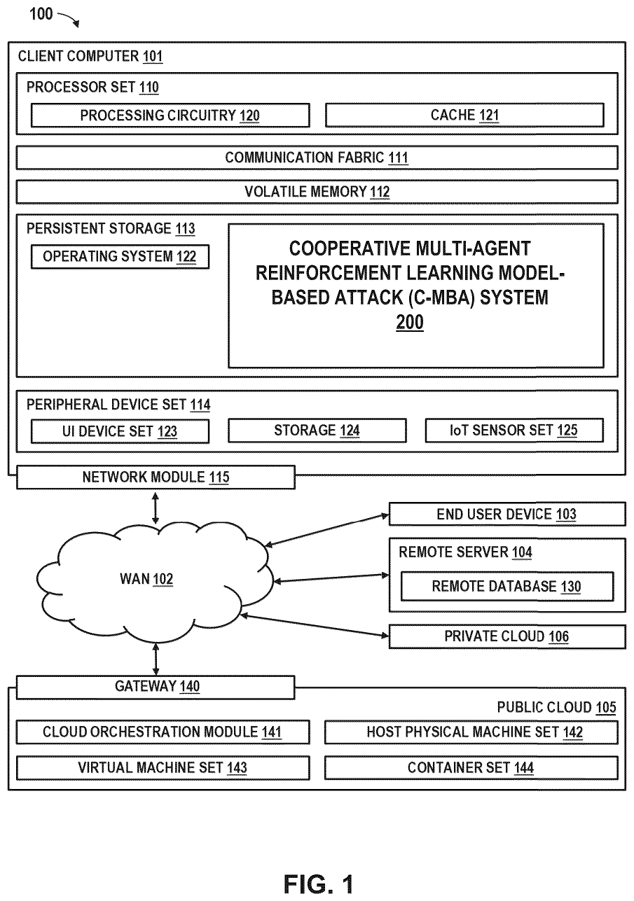

FIG. 1 depicts a computing environment 100 according to an embodiment of the present invention. Computing environment 100 contains an example of an environment for the execution of at least some of the computer code involved in performing the inventive methods, such as a cooperative multi-agent reinforcement learning (c-MARL) system model-based attack (c-MBA) system 200 configured for training for and carrying out model-based adversarial attacks on c-MARL systems. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

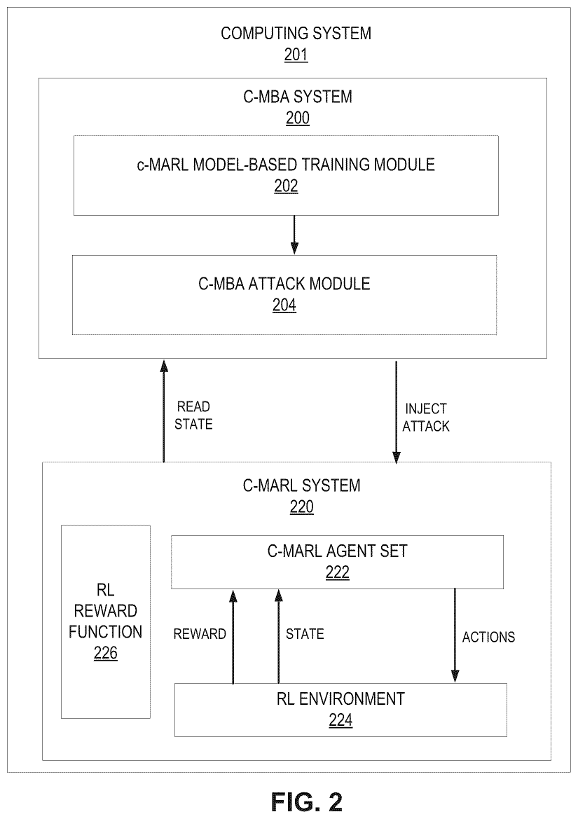

FIG. 2 shows a block diagram of an exemplary computing system 201 in accordance with aspects of the invention. In embodiments, computing system 201 implements example c-MBA system 200 of this disclosure, as introduced above. Computing system 201 may be implemented in a variety of configurations for implementing, storing, running, and/or embodying c-MBA system 200. Computing system 201 in various examples may comprise a cloud-deployed computing configuration, comprising processing devices, memory devices, and data storage devices dispersed across data centers of a regional or global cloud computing system, with various levels of networking connections, such that any or all of the data, code, and functions of c-MBA system 200 may be distributed across this cloud computing environment. In other examples, computing system 201 may comprise a single laptop computer, or a specialized machine learning workstation equipped with one or more specialized-grade graphics processing units (GPUs) and/or other specialized processing elements, or a collection of computers networked together in a local area network (LAN), or one or more server farms or data centers below the level of cloud deployment, or any of a wide variety of computing and processing system configurations, any of which may implement, store, run, and/or embody c-MBA system 200.

In embodiments, computing system 201 of FIG. 2, and any one or more computing devices or components thereof, comprises c-MARL model-based training module 202 and c-MBA perturbation optimizer attack module 204, each of which may comprise modules of code of block 200 of FIG. 1. These modules of the code of block 200 are executable by the processing circuitry 120 of FIG. 1 to perform the inventive methods as described herein. Computing system 201, and any one or more computing devices or components thereof, may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In the example of FIG. 2, c-MBA system 200 is configured to perform adversarial attacks on c-MARL system 220. The c-MARL system 220 comprises a c-MARL agent set 222 configured to iteratively observe the state of an RL training environment 224, perform actions that influence RL environment 224, and receive rewards based on changes in the state the agents of c-MARL agent set 222 observe in RL environment 224, according to a selected RL reward function 226. The c-MBA system 200 is configured to observe the state of c-MARL system 220, including of RL environment 224, reward function 226, and c-MARL agent set 222, and to inject attacks into c-MARL system 220, as further described below.

As specific illustrative examples of the useful advantages of examples of this disclosure, c-MARL system may be configured to train a control system for a self-driving or self-piloting vehicle such as a car or spacecraft. Reward function 226 may be selected as a set of performance goals such as to propel the vehicle along authorized human-selected trajectories, and to avoid crashing. The c-MBA system 200 may perform adversarial attacks to try to force the c-MARL agent set 222, or at least one or more agents thereof, to transition toward a contradictory, targeted failure state of c-MARL system 220 and to sabotage its purposes according to RL reward function 226, such as by veering in random directions or to crash the vehicle. Then by assessing from these successful adversarial attacks, design engineers and/or machine learning systems may become enabled to revise and refine c-MARL systems to become more robust and enabled to avoid such failures in real-world operation, in ways that may likely never have become apparent without performing adversarial attacks using c-MBA system 200 of this disclosure.

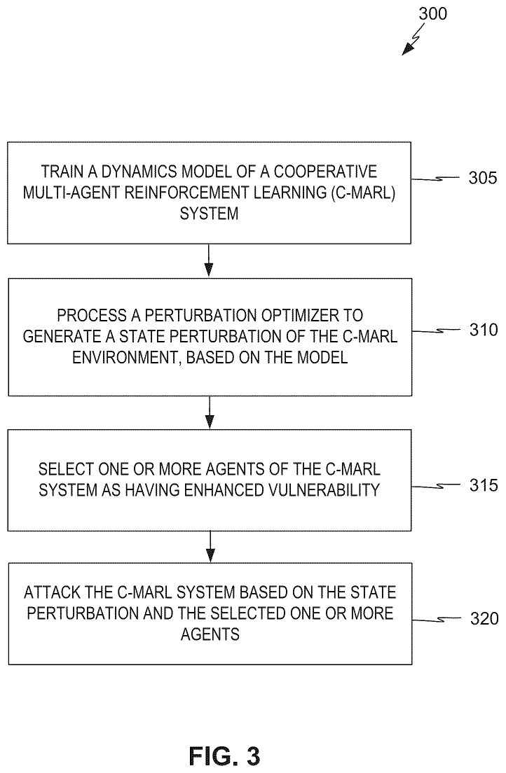

FIG. 3 shows a flowchart of an exemplary method 300 in accordance with aspects of the present invention. Steps of the method may be carried out by computing system 201 of FIG. 2, implementing, running, and/or embodying c-MBA system 200, and are described with reference to elements depicted in FIG. 2.

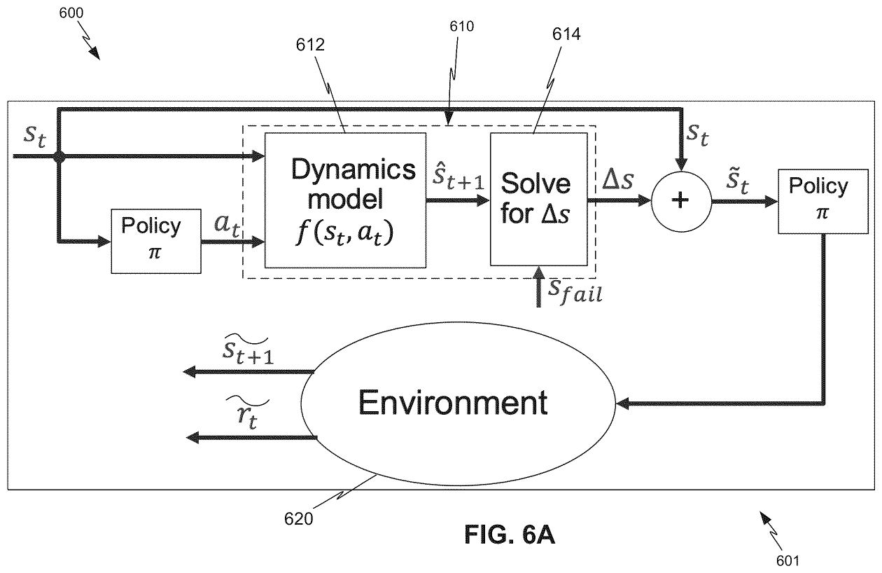

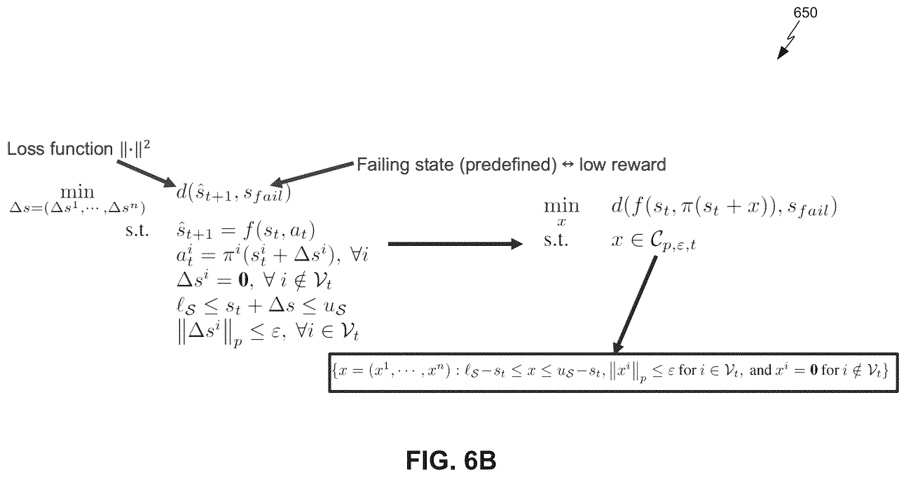

Method 300 is described in terms of a dynamics model, in this example. In various examples, a dynamics model may generally be considered to include a model that approximates the dynamics of an environment, takes current state and agents' actions as inputs, and returns a state to which the multi-agent system will transition. At step 305, computing system 201 implementing c-MBA system 200 performs supervised learning training of a dynamics model of a cooperative multi-agent reinforcement learning (c-MARL) environment, for an attack system configured for attacking a cooperative multi-agent reinforcement learning (c-MARL) system, such as may be performed by c-MARL model-based training module 202 and of FIG. 2, and as further described below, such as with reference to FIGS. 5, 6A, and 6B. For example, c-MBA system 600 of FIG. 6A may output an adversarially influenced state to one or more c-MARL agents, which in effect distorts the worldview of the one or more agents c-MBA system 200 selects for attack training, which the one or more agents incorporate into their RL policy that guides their actions. The training of the attack system comprises training with an attack model. At step 310, computing system 201 implementing c-MBA system 200 processes a perturbation optimizer to generate a state perturbation of the c-MARL environment, which may be an optimized state perturbation of the c-MARL environment, based on the dynamics model of the c-MARL environment. This may include running or implementing a perturbation optimizer or a perturbation selector, and selecting a perturbation that optimally moves the c-MARL system closer to the targeted failure state, and in various examples, as close to the targeted failure state as the perturbation is capable of. At step 315, computing system 201 implementing c-MBA system 200 selects one or more agents of the c-MARL system as having enhanced vulnerability. At step 320, computing system 201 implementing c-MBA system 200 attacks the c-MARL system with the attack system, based on the state perturbation and the selected one or more agents, such as may be performed by c-MBA perturbation optimizer attack module 204 of FIG. 2, and as further described below, such as with reference to FIGS. 5, 6A, and 6B, including by attack module 610 of FIG. 6A. Steps 305, 310, 315, and 320 may also be performed in an iterative feedback loop and iteratively flow into each other, such that there may be overlap between aspects of both, and the steps may be performed in any order and any degree of simultaneity and/or overlap, in different examples.

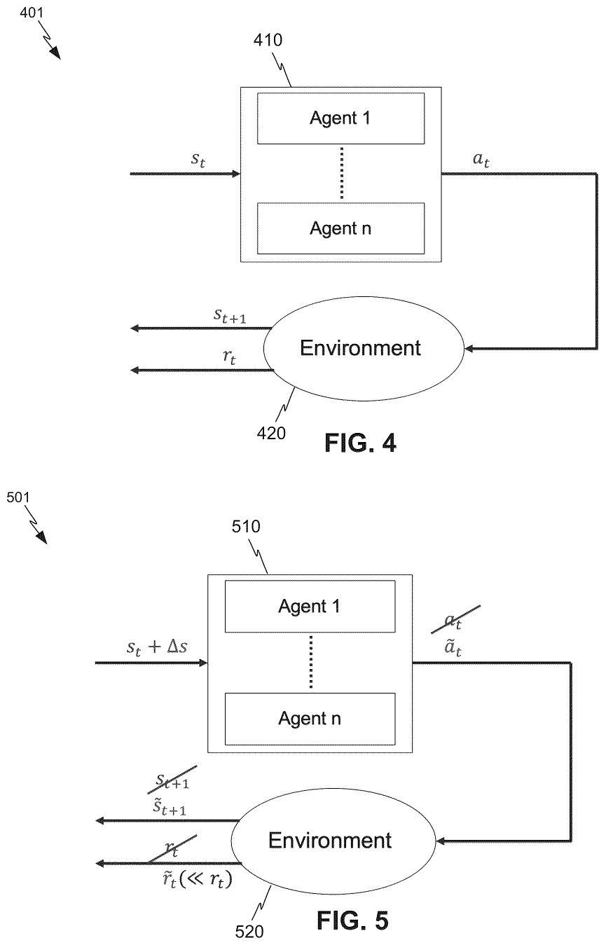

FIG. 4 depicts a conceptual diagram of a cooperative multi-agent reinforcement learning (c-MARL) system 401, in accordance with aspects of this disclosure. Multiple agents 1-n of multi-agent system 410 each iteratively receive as inputs observations of a state s of an environment at a time t, sₜ, and each react by performing a set of actions a in the corresponding time interval t, or aₜ, within or upon environment 420. While observation and state may be used interchangeably in contexts in which observation can validly be assumed always to accurately reflect state, observation may also differ from state in some contexts in a c-MARL system. The agent actions aₜ modify environment 420 to yield both agent rewards r for time interval t, or rₜ, in response to agent actions aₜ, and modified environment state sₜ₊₁ at time interval t+1. Modified environment state sₜ₊₁ feeds back to agents 1-n of agent system 410 for the next iteration. Implementations of c-MARL system 401 may be used for any of a wide variety of RL applications, including such as controlling a robot or controlling an electrical power grid, in various examples.

FIG. 5 depicts a conceptual diagram of a cooperative multi-agent reinforcement learning (c-MARL) system 501 in a perturbed state due to an adversarial attack by a c-MARL model-based attack (c-MBA) system, such as c-MBA system 200 of FIGS. 1 and 2, in accordance with aspects of the present disclosure. Deep neural networks are vulnerable to adversarial examples, where a small and often imperceptible adversarial perturbation can easily fool the state-of-the-art deep neural network classifiers. Deep reinforcement learning (DRL) agents are also vulnerable to adversarial attacks. This disclosure focuses on evaluating robustness in cooperative multi-agent reinforcement learning (c-MARL) setting, where a group of agents is trained to generate joint actions to maximize the team reward of the group of agents, and which is more complex than single-agent RL systems. Various examples of this disclosure particularly focus on vulnerability of c-MARL agents to adversarial attacks in a continuous action space, as opposed to in a discrete action space. Various examples of this disclosure are directed to a c-MARL model-based attack (c-MBA) system, such as c-MBA system 200, which may function as a model-based adversarial attack framework, in various examples.

A c-MBA system in various examples of this disclosure may identify, select, and target particular agents in a multi-agent RL system that are of enhanced vulnerability to adversarial attack. In some examples, a c-MBA system in various examples of this disclosure may identify, select, and target particular agents in a multi-agent RL system that are the most vulnerable agents to adversarial attack, among the multiple agents in the multi-agent RL system.

As FIG. 5 shows, c-MBA system 200 may inject, output, add, or introduce a perturbation Δs to iterative environment state sₜ as input to agents 1-n of multi-agent system 510. Whereas agent system 510 would have output normal, productive action set aₜ in the event of observing an uncorrupted environment state sₜ, agent system 510 now outputs to or within environment 520 a modified or corrupted action set [symbol] responsive to receiving the perturbed or corrupted input sₜ+Δs= [symbol] due to the interference of c-MBA system 200. The agents respond to the perturbed inputs [symbol] by performing corrupted actions [symbol] , and in response to c-MARL system 501 interacting with environment 520 using corrupted actions [symbol] , c-MARL system 501 evolves to a new perturbed environment state \tilde{s}ₜ₊₁ that incorporates or reflects the corrupted agent actions upon it, and by outputting perturbed agent rewards [symbol] that also incorporate or reflect the perturbed agent actions as processed by the reward function. The perturbed agent rewards [symbol] are less than, and may be quite substantially less than, the unperturbed agent rewards rₜ within the RL reward function; that is, [symbol] <<rₜ. In other words, the perturbed agent rewards [symbol] substantially degrade the evolution of the agents' actions toward the desired RL training outcomes, as encoded in the RL reward function that the agents are supposed to be working to maximize. FIG. 5 shows the actions, state, and rewards that would have been outputted in the unperturbed system crossed out and replaced by the corresponding variables marked with tildes to indicate adversarially perturbed versions of the actions, state, and rewards due to the attack injected by c-MBA system 200 with its adversarial perturbation Δs superimposed upon the environmental state that c-MBA system 200 surfaces to one or more of the agents of agent set 510.

FIG. 6A depicts a conceptual diagram of a c-MARL model-based attack (c-MBA) system 600 interacting with a c-MARL system 601 to carry out c-MBA attacks on c-MARL system 600, in accordance with aspects of the present disclosure. A c-MBA system 600 may comprise an attack model 610. Attack model 610 may comprise a neural network environment dynamics model 612 (“environment dynamics model 612,” “dynamics model 612”) of an RL environment of the c-MARL system; and an attack generating perturbation optimizer 614. Dynamics model 612 and perturbation optimizer 614 of FIG. 6 may be example implementations of c-MARL model-based training module 202 and c-MBA perturbation optimizer attack module 204, respectively, of the example of FIG. 2. Dynamics model 612 and perturbation optimizer 614 of FIG. 6 may perform, carry out, and/or embody example implementations of steps 305, 310, 315, and 320 of the example method of FIG. 3. A c-MBA system 600 may conduct a first series of operations to train environment dynamics model 612. A c-MBA system 600 may collect a training dataset [symbol] ₜᵣ by performing roll-out from the RL environment 620 of the c-MARL system using a productive agent training policy π(s, a) (policy π as a function of environment state s and multi-agent set actions a). The c-MBA system 600 may also collect a random dataset [symbol] _{rd} by performing roll-out from RL environment 620 using a random policy. The c-MBA system 600 may form the combined training dataset [symbol] = [symbol] ₜᵣ∪ [symbol] _{rd}. The c-MBA system 600 may train neural network environment dynamics model f(s, a; ϕ)) 612 to determine or estimate the environment dynamics:

$${min}_{ϕ} {\sum }_{t ∈ 𝒟} {‖ f ( {s}_{t} , {a}_{t} ; ϕ ) - {s}_{t + 1} ‖}^{2}$$

This system may include n agents, in which agent i receives state sₜⁱ and takes action aₜⁱ, where sₜ is joint global state, and aₜ is joint global action. π(s, a) is a pretrained c-MARL policy.

The c-MBA system 600 may then perform adversarial attack training in support of performing adversarial attacks on a c-MARL system. The system of equations 650 shown in FIG. 6B, and the equations shown below, show a system of equations that c-MBA system 600 may carry out to perform adversarial perturbation attack training runs, in accordance with aspects of this disclosure. The c-MBA system 600 may carry out adversarial perturbation attack training runs, in which ε is a state perturbation budget constraint, Δsⁱ is a state perturbation for agent i, and is a selected adversarial attack targeted failure state, selected for optimizing for a failing reward function that acts contrary to or in opposition to the normal c-MARL reward function, where the agents may normally be expected to take actions that correlate with high rewards in accordance with the training of the c-MARL system. The c-MBA system 600 may then, at each time step, solve the set of equations in FIG. 6B, and as follows, to determine an optimal state perturbation.

$${min}_{Δ s = ( Δ {s}^{1} , … , Δ {s}^{μ} )} d ( {\hat{s}}_{i + 1} , {s}_{fail} )$$

$$s . t .$$

$${\hat{s}}_{t + 1} = f ( {s}_{t} , {a}_{t} )$$

$${a}_{t}^{i} = {π}^{i} ( {s}_{t}^{i} + Δ {s}^{i} ) , ∀ i$$

$$Δ {s}^{i} = 0 , ∀ i ∉ {𝒱}_{t}$$

$${ℓ}_{𝒮} \leq {s}_{t} + Δ s \leq {u}_{𝒮}$$

$${‖ Δ {s}^{i} ‖}_{p} \leq ε , ∀ i ∈ {𝒱}_{t}$$

$${min}_{x} d ( f ( {s}_{t} , π ( {s}_{t} + x ) ) , {s}_{fail} )$$

$$s . t .$$

$$x ∈ {c}_{p , ϵ , i}$$

| Algorithm 1 cMBA algorithm at timestep t | |
|---|---|
| 1: | Initialization: |
| 2: | Given sₜ, s_{fail}, π, f, Vₜ; initialize Δs = ε * sign(x) |
| | for x~N(0, 1), attack budget ε, p; choose learning |
| | rate η > 0 |
| 3: | For k = 0, . . . , K − 1 do |
| 4: | Compute aₜ = (aₜ¹, . . . , aₜⁿ) as |
| | ${a}_{t}^{i} = \{ \begin{matrix}{π}^{i} ( {s}_{t}^{i} + Δ {s}^{i} ) & if i ∈ {V}_{t} \\ {π}^{i} ( {s}_{t}^{i} ) & otherwise\end{matrix} .$ |
| 5: | Compute ŝₜ₊₁ + f(sₜ, aₜ) |
| 6: | Update Δs as |
| | Δsₖ₊₁ = proj_{C}_{_{p,s,t}} [Δsₖ − η∇_{Δs}d(śₜ₊₁, s_{fail})] |
| 7: | End For |

The c-MBA system 600 may thus train and perform an adversarial attack on a c-MARL system. The c-MBA system 600 may thus output and inject a supervised learning trained or RL-trained perturbed environment state sₜ+Δs= [symbol] into the RL policy training of the c-MARL agent set, to perturb the c-MARL policy π into a perturbed c-MARL agent set policy \tilde{π}, which perturbs the agent sets' action set upon RL environment 620. RL environment 620 then transitions to corrupted c-MARL state \tilde{s}ₜ₊₁ and adversarially perturbed reward [symbol] as a result of the corrupted actions, which feeds as the next time interval reward input to the c-MARL agent set, in various examples. The c-MBA system 600 may continue to iteratively adversarially perturb and degrade the rewards fed to the c-MARL agent set over time.

Dynamics model 612 of the RL environment 620 of the c-MARL system may thus be configured to generate a predicted subsequent state of the RL environment as a function of the state and agent actions performed in the c-MARL RL training. Attack generating perturbation optimizer 614 may thus be configured to generate a state perturbation based on the predicted subsequent c-MARL state and a targeted failure state of the c-MARL system that is in opposition to a reward function of the RL environment of the c-MARL system.

In some examples, the c-MBA system 600 may further perform an adversarial attack that includes victim agent selection. The c-MBA system 600 may perform calculations to determine the solution of the following set of equations, and take that solution as the optimal state perturbation:

$${min}_{Δ s , w} d ( {\hat{s}}_{t + 1} , {s}_{fail} )$$

$$s . t .$$

$${\hat{s}}_{t + 1} = f ( {s}_{t} , {a}_{t} )$$

$${a}_{i}^{i} = {π}_{i} ( {s}_{t}^{i} + {w}_{i} \cdot Δ {s}^{i} ) , ∀ i$$

$${ℓ}_{𝒮} \leq {s}_{t}^{i} + Δ {s}^{i} \leq {u}_{𝒮} , ∀ i$$

$${‖ Δ {s}^{i} ‖}_{p} \leq ε , ∀ i$$

$${w}_{i} ∈ \{ 0 , 1 \} , ∀ i$$

$${\sum }_{i} {w}_{i} = {n}_{v}$$

Using W(s; θ)∈ [symbol] ⁿ to distribute the perturbation, this system of equations can be reformulated as:

$${min}_{Δ s , θ} d ( {\hat{s}}_{t + 1} , {s}_{fail} )$$

$$o . t .$$

$${\hat{s}}_{t + 1} = f ( {s}_{t} , {a}_{t} )$$

$${a}_{t}^{i} = {π}^{i} ( {s}_{t}^{i} + {W}_{i} ( {s}_{t} ; θ ) \cdot Δ {s}^{i} ) , ∀ i$$

$${ℓ}_{𝒮} \leq {s}_{t}^{i} + Δ {s}^{i} \leq {u}_{𝒮} , ∀ i$$

$${‖ Δ {s}^{i} ‖}_{p} \leq ε , ∀ i$$

$$0 \leq {W}_{i} ( {s}_{t} ; θ ) \leq 1 , ∀ i$$

A c-MBA system may thereby identify and select agents having enhanced vulnerability, and in various examples, the most vulnerable agents in the c-MARL agent set to perturb, and use that selection to perform an adversarial attack that takes advantages of vulnerable victim agent selection. A c-MBA system may select and perturb the particular agents out of the cooperative multi-agent RL set whose perturbation results in imposing the most deleterious effects on the total agent set performance, in various examples. Thus, the c-MARL system comprises a set of agents, and the c-MBA system may identify one or more of the agents as having enhanced vulnerability, and target attacks on the one or more of the agents identified as having enhanced vulnerability. Enhanced vulnerability in this usage may thus include enhanced capability of inflicting deleterious effects on the c-MARL trained rewards, and enhanced capability of transitioning the c-MARL system toward a targeted failure state, in various examples. The c-MBA system may thus target its attack resource budget more effectively than by attacking the agent set as a whole or attacking the agents at random, and achieve greater adversarial attack performance, for the same attack resource budget, in various examples. Selecting the one or more agents of the c-MARL system as having enhanced vulnerability may thus include identifying one or more of the agents as able to achieve greater adversarial attack performance, for the same attack resource budget, in various examples. A c-MBA system may thus attack a c-MARL system based in part on a selected one or more agents selected for having enhanced vulnerability, in that the c-MBA system targets its adversarial attack resources on the one or more selected agents that are particularly vulnerable to attack and to function as conduits for the attack to achieve the most effective transitioning toward the targeted failure state, instead of maximizing the normal c-MARL rewards, in various examples.

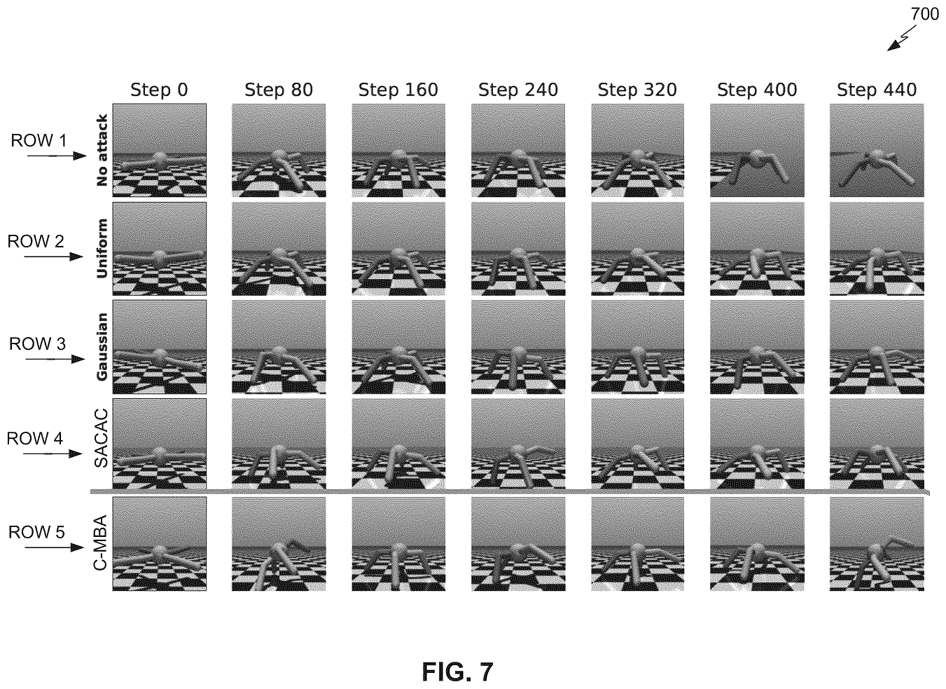

FIG. 7 depicts a grid 700 of a number of comparative representative time series of images showing the state of a standardized reinforcement learning (RL) control article (in the form of a simulated robot with four limbs connected to a central node) carrying out MARL control software, being controlled by a MARL agent set, which may have four agents, with one agent of the MARL agent set under dedicated control of each limb, in a MuJoCo (Multi-Joint Dynamics with Contact open-source physics simulator) environment, free of any attack (first row) and under various comparative model-free adversarial RL control software attacks (rows 2 through 4), and by a c-MBA system in accordance with aspects of the present disclosure (row 5). FIG. 7 demonstrates successful adversarial performance of an example implementation of a c-MBA system in accordance with aspects of the present disclosure.

The multi-agent reinforcement learning (MARL) control agent set may be fed and be responsive to a reward function relative to the performance of the control article, i.e., the simulated four-legged robot, in the simulated world. The MARL agent set, acting as the robot's “brain,” may begin with zero knowledge and zero traditional, explicitly human-coded algorithmic software of how to operate the control article robot. The MARL agent set acting as the robot's brain instead trains itself in how to control the robot from scratch, purely by an RL training process, starting only with the RL training architecture, including the capability to generate control outputs that have an effect in its RL environment (control of the robotic limbs within the limitations imposed by the robot engineering design and the laws of physics), to observe changes in its world (the RL environment) such as achieving movement and propelling itself in certain directions in the world, and to receive reward signals that match its RL reward function to a greater or lesser degree, thereby reinforcing actions that promote the goals encoded in the reward function (e.g., propelling itself in a selected direction), and inhibiting actions that contradict the goals encoded in the reward function (e.g., immobilizing itself). The reward function may specify reward conditions, such as propelling the robot in a selected direction in the simulated world, where the more efficiently the robot propels itself (i.e., under control of the MARL agent set) in the selected direction, the greater its rewards in each time iteration. The robot may have physical constraints on its freedom of articulation such that it has a right side up, and such that it would become immobilized if it were to flip upside down, and incapable of any possible motions to right itself again, which would deprive it of any further rewards (which are for propelling itself in the selected direction), and the threat of which the MARL agent set may incorporate into its responsive behavior to its reception of the rewards.

The particular model-free adversarial attacks used for comparison in the examples of FIG. 7 include uniform (row 2), Gaussian (row 3), and a single-agent clandestine adversarial conversion (SACAC) technique (row 4). The columns of grid 700 show the control article at like representative discretized time intervals (i.e. at steps 0, 80, 160, 240, 320, 400, and 440) in respective c-MARL simulations in each of the c-MARL settings associated with each of the rows as indicated above. By step 440 (right-most column) in the attack-free control (row 1) and in the model-free attacks (rows 2 through 4), the control article under control of the c-MARL agent set is continuing to perform well, under the conditions of its reward function (e.g., remaining upright and continuing to learn to propel itself in a selected direction in the simulated world, and avoiding immobilizing itself by flipping over onto its back, beginning from zero knowledge of how to operate). That is, the c-MARL agent set remained successful in responding to its c-MARL training.

In sharp contrast, in the multi-agent set being attacked by a c-MBA system of this disclosure (row 5), by step 440, the c-MARL agent set has controlled the control article robot to flip over onto its back—representing a forfeiture of all possible future rewards, and a complete failure of the c-MARL agent set and its purpose, to train itself to continue propelling itself in the selected direction as optimally as possible. This complete failure of the c-MARL agent set represents a complete victory by c-MBA system 200 of this disclosure, which successfully perturbs and interferes with the effective actions and effective reward responses of the MARL agent set to the point that the c-MARL agent set completely sabotages itself. This comparison of FIG. 7 thus shows how an example c-MBA system 200 of this disclosure may achieve a complete success where other adversarial c-MARL systems could only achieve a partial degradation of performance of the c-MARL agent sets they attacked.

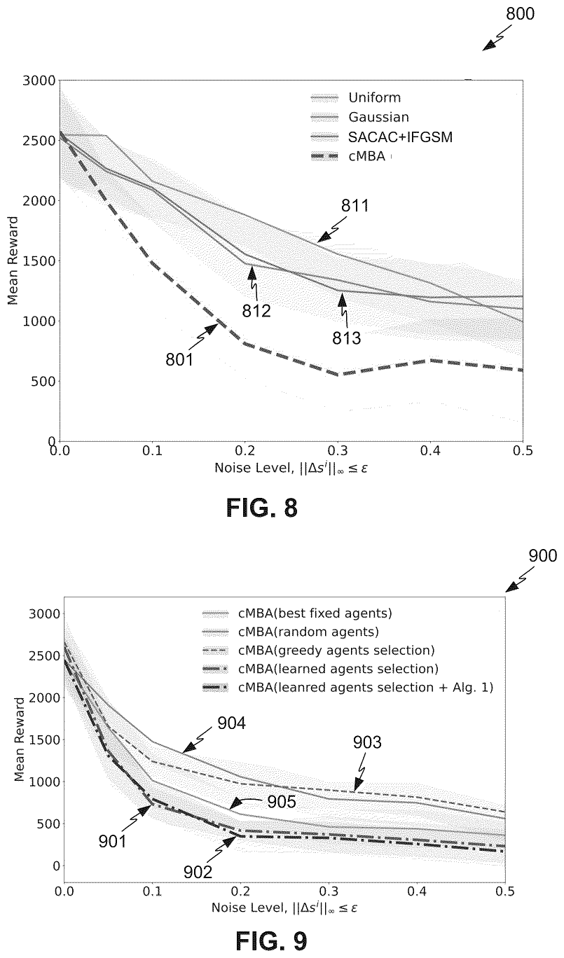

FIG. 8 depicts a graph 800 of mean RL rewards relative to noise levels for a c-MBA system in accordance with aspects of the present disclosure, compared to the same comparative baseline model-free adversarial RL control software attacks discussed above with reference to FIG. 7, in accordance with aspects of this disclosure. Graph 800 shows that a c-MBA system of this disclosure (performance curve 801) achieves substantially greater performance, i.e., substantially greater degradation of mean reward, across the entire range of noise levels, compared with other model-free adversarial systems tested, including uniform (at 811), Gaussian (at 812), and single-agent clandestine adversarial conversion (SACAC) plus iterative fast gradient sign method (iFGSM) (at 813). FIG. 8 demonstrates that a c-MBA system in accordance with aspects of the present disclosure is much more effectively capable of leveraging noise into degradation of RL agent rewards, across the entire range of noise levels.

FIG. 9 depicts a graph 900 of mean RL rewards relative to noise levels for various different example implementations of c-MBA systems, in accordance with aspects of the present disclosure. Graph 900 shows performance curves specifically for example implementations of c-MBA systems of this disclosure in: a best fixed agents c-MBA system (performance curve at 905), a random agents c-MBA system (at 904), a greedy agents selection c-MBA system (at 903), a learned agents selection c-MBA system (at 902), and a learned agents selection plus algorithm 1 c-MBA system (i.e., algorithm 1 as described above) (at 901), as various example c-MBA systems of this disclosure. As shown, performance is measured in terms of degrading the mean reward of the c-MARL system being attacked, relative to the noise level usable as input. As graph 900 shows, in the particular implementations shown here, the learned agents selection c-MBA system and the learned agents selection plus algorithm 1 c-MBA system achieved the best performance among the example implementation c-MBA systems tested, in the testing session represented; and with negligible differences between these two top-performing c-MBA examples at lower levels of noise (under 0.2 in the indicated units), with a slight performance edge by the learned agents selection plus algorithm 1 c-MBA system at higher levels of noise (above 0.2 in the indicated units). In other implementations, depending on various details of how the c-MBA systems are implemented, any of these examples may achieve higher performance. The example c-MBA systems whose performance outcomes are shown in FIG. 9 are not an exhaustive or limiting listing, and various other example c-MBA systems of this disclosure may also be implemented, which may have any of a variety of performance characteristics.

Examples of this disclosure thus provide novel model-based systems and methods to perform adversarial attacks for cooperative multi-agent reinforcement learning (c-MARL). In various examples, these novel model-based c-MARL attack (c-MBA) systems and methods include: training a neural network model to estimate environment dynamics (e.g., training dynamics model 612 of FIG. 6, in a supervised learning process), and solving a constrained nonconvex subproblem using the trained dynamics model to find the optimal state perturbation at each timestep (e.g., running perturbation optimizer 614 of FIG. 6 to find an optimal state perturbation of the c-MARL system, using dynamics model 612). A c-MBA system of various examples of this disclosure may be directly applied to a variety of more robust control systems than are possible in the prior state of the art in many valuable real-world applications that have continuous and nonconvex action space, rather than discrete and/or convex action space, such as self-driving vehicles, surgical robots, and utility electrical grids, as a few examples. Various examples of this disclosure further include novel systems, methods, and algorithms for victim selection to select the best subset of victim agents for achieving a successful MARL adversarial attack. Various examples of this disclosure include a framework that applies to c-MARL environments with a continuous action space, which presents certain more complex challenges compared to a discrete action space. The attack system is thus configured to detect vulnerability of the agents to adversarial attacks in a continuous action space, in various examples.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
training, by a computing system, a dynamics model of a cooperative multi-agent reinforcement learning (c-MARL) environment of a c-MARL system;
processing, by the computing system, a perturbation optimizer to generate a state perturbation of the c-MARL environment, based on the dynamics model;
selecting one or more agents of the c-MARL system as having enhanced vulnerability; and
attacking, by the computing system, the c-MARL system based on the state perturbation and the selected one or more agents.

2. The method of claim 1, further comprising:
performing supervised learning training of the dynamics model based on the c-MARL system.

3. The method of claim 2, wherein attacking the c-MARL system comprises injecting the state perturbation into a state input to a multi-agent system of the c-MARL system.

4. The method of claim 3, wherein processing the perturbation optimization formulation further comprises optimizing the state perturbation to transition the c-MARL system to a targeted failure state based on predictions generated by the dynamics model, wherein actions taken are in opposition to a reward function of the c-MARL environment.

5. The method of claim 1, wherein the dynamics model comprises:
a dynamics model of a reinforcement learning (RL) environment of the c-MARL system.

6. The method of claim 5, wherein the dynamics model is configured to generate a predicted subsequent state of the c-MARL system as a function of a current state and actions performed in the c-MARL system.

7. The method of claim 5, wherein the perturbation optimizer is configured to generate a state perturbation based on the predicted subsequent state of the c-MARL system and a targeted failure state of the c-MARL system that is in opposition to a reward function of the c-MARL environment.

8. The method of claim 1, wherein generating the state perturbation of the c-MARL environment based on the dynamics model is configured for degrading a performance of a trained c-MARL policy of the c-MARL system.

9. The method of claim 1, wherein the c-MARL system comprises a set of agents, wherein selecting the one or more agents of the c-MARL system as having enhanced vulnerability comprises:
identifying one or more of the agents as able to achieve greater adversarial attack performance, for the same attack resource budget.

10. The method of claim 1, wherein the attack system is configured to detect vulnerability of agents in the c-MARL system to adversarial attacks in a continuous action space.

11. A computer program product comprising one or more computer readable storage media having program instructions collectively stored on the one or more computer readable storage media, the program instructions executable to:
train a dynamics model of a cooperative multi-agent reinforcement learning (c-MARL) environment;
process a perturbation optimizer to generate a state perturbation of the c-MARL environment, based on the dynamics model;
select one or more agents of the c-MARL system as having enhanced vulnerability; and
attack the c-MARL system based on the state perturbation and the selected one or more agents.

12. The computer program product of claim 11, wherein the program instructions are further executable to:
perform supervised learning training of the dynamics model based on the c-MARL system,
wherein attacking the c-MARL system comprises injecting the state perturbation into a state input to the c-MARL system, and
wherein processing the perturbation optimization formulation further comprises optimizing the state perturbation to transition the c-MARL system to a targeted failure state based on predictions generated by the dynamics model, wherein actions taken are in opposition to a reward function of the c-MARL environment.

13. The computer program product of claim 11, wherein the dynamics model comprises:
a dynamics model of a reinforcement learning (RL) environment of the c-MARL system,
wherein the dynamics model is configured to generate a predicted subsequent state of the multi-agent system as a function of a current state and actions performed in the c-MARL system, and
wherein the perturbation optimizer is configured to generate a state perturbation based on the predicted subsequent state of the c-MARL system and a targeted failure state of the c-MARL system that is in opposition to a reward function of the c-MARL environment.

14. The computer program product of claim 11, wherein generating the state perturbation of the c-MARL environment based on the dynamics model is configured for degrading a performance of a trained c-MARL policy of the c-MARL system.

15. The computer program product of claim 11, wherein the c-MARL system comprises a set of agents, wherein the program instructions are further executable to:
identify one or more of the agents as having enhanced vulnerability; and
target the attacking on the one or more of the agents identified as having enhanced vulnerability.

16. A system comprising:
a processor set, one or more computer readable storage media, and program instructions collectively stored on the one or more computer readable storage media, the program instructions executable to:
train a dynamics model of a cooperative multi-agent reinforcement learning (c-MARL) environment;
process a perturbation optimizer to generate a state perturbation of the c-MARL environment, based on the dynamics model;
select one or more agents of the c-MARL system as having enhanced vulnerability; and
attack the c-MARL system based on the state perturbation and the selected one or more agents.

17. The system of claim 16, wherein the program instructions are further executable to:
perform supervised learning training of the model based on the c-MARL system,
wherein attacking the c-MARL system comprises injecting the state perturbation into a state input to a multi-agent system of the c-MARL system, and
wherein processing the perturbation optimization formulation further comprises optimizing the state perturbation to transition the c-MARL system to a targeted failure state based on predictions generated by the dynamics model, wherein actions taken are in opposition to a reward function of the c-MARL environment.

18. The system of claim 16, wherein the attack model comprises:
a dynamics model of a reinforcement learning (RL) environment of the c-MARL system,
wherein the dynamics model is configured to generate a predicted subsequent state of the c-MARL system as a function of a current state and actions performed in the c-MARL system, and
wherein the perturbation optimizer is configured to generate a state perturbation based on the predicted subsequent state of the multi-agent system and a targeted failure state of the c-MARL system that is in opposition to a reward function of the c-MARL environment.

19. The system of claim 16, wherein generating the state perturbation of the c-MARL environment based on the dynamics model is configured for degrading a performance of a trained c-MARL policy of the c-MARL system.

20. The system of claim 16, wherein the c-MARL system comprises a set of agents, wherein the program instructions are further executable to:
identify one or more of the agents as having enhanced vulnerability; and
target the attacking on the one or more of the agents identified as having enhanced vulnerability.
